(19) United States
(12) Patent Application Publication
(10) Pub. No.: US 2024/0351294 A1
(43) Pub. Date: Oct. 24, 2024

(54) END FACE ASSESSMENT

(71) Applicant: Georg Fisher Rohrleitungssysteme AG, Schaffhausen (CH)

(72) Inventors: Alessandro ANELLO, Schaffhausen (CH); Edin Hasific, Schaffhausen (CH); Mariano Gutierrez, Kreuzlingen (CH)

(21) Appl. No.: 18/635,227

(22) Filed: Apr. 15, 2024

(30) Foreign Application Priority Data
Apr. 18, 2023 (EP) 23168524.9

(51) Int. Cl. B29C 65/82; B29C 65/20; B29L 23/00

(52) U.S. Cl. CPC B29C 65/8253; B29C 65/20; B29L 2023/22

(57) ABSTRACT

A method for quality assessment of a butt weld of plastic parts, preferably pipeline components, by means of a butt welding machine, wherein two plastic parts are clamped in a coaxial position to one another by means of clamping devices and fixed, wherein the mutually opposite end faces of the plastic parts are planed flat by means of a plane which can be introduced in between, and the plastic part ends are melted by means of a heating mirror which can be introduced in between and then joined after melting, wherein after melting, the resulting melt regions on the end faces of the plastic part ends are inspected by means of at least one camera.

### CROSS-REFERENCE TO RELATED APPLICATION

This application claims the benefit and priority of European Patent Application No. 23168524.9 filed Apr. 18, 2023. The entire disclosure of the above application is incorporated herein by reference.

### BACKGROUND OF THE INVENTION

### Technical Field

The invention concerns a method for quality assessment of a butt weld of plastic parts, preferably pipeline components, by means of a butt welding machine, wherein the two plastic parts are clamped in a coaxial position to one another by means of clamping devices and fixed, wherein the mutually opposite end faces of the plastic parts are planed flat by means of a plane which can be introduced in between, and the plastic part ends are melted by means of a heating mirror which can be introduced in between and then joined after melting; and a butt welding machine comprising a base unit, a plane, a heating mirror, a controller, at least two coaxially mutually opposite clamping devices which are adjustable along the longitudinal axis of the plastic parts to be welded, wherein the two mutually facing clamping devices of the two plastic part ends to be welded together each have a mutually facing front side.

### Discussion

The prior art discloses methods and butt welding machines for welding plastic parts which are normally used for welding pipes and pipeline components used in industry or utility services. Contactless welding machines, e.g. IR welding machines, are often used if high requirements are imposed on the cleanliness of the pipeline and hence also on the weld.

EP 0 899 085 B1 discloses a method for welding plastic parts in which the cooling process is monitored by means of an infrared sensor, and the cooling time controlled to achieve an optimal weld.

The disadvantage here is that even when the optimal cooling process is applied, nonetheless cavities can occur in the weld seam which are not detected and thereby create a poor weld connection in a system.

It is an aspect of the invention to propose a method and an associated butt welding machine in which the quality of the weld connection is inspected in good time without the welding process needing to be interrupted.

### SUMMARY

This aspect is achieved according to the preferred embodiment of the invention in that after melting, the resulting melt regions on the end faces of the plastic part ends are inspected by means of at least one camera, and for this at least one camera for photographing the plastic part end faces is arranged on the butt welding machine.

In the method according to the invention for quality assessment of a butt weld of plastic parts, preferably pipeline components, by means of a butt welding machine, the two plastic parts are clamped in a coaxial position to one another by means of clamping devices and fixed. Pipeline components include pipes, fittings and also connections and valves which can be welded together. In the method according to the invention, the mutually opposite end faces of the plastic parts are planed flat by means of a plane which can be introduced in between. This removes unevenness or contamination, which is essential for the quality of the weld connection. Then the plastic part ends are melted by means of a heating mirror which can be introduced in between. The heating mirror is arranged between the plastic part ends instead of the previously used plane, and contactlessly heats the plastic part ends, preferably by means of an infrared heat mirror.

Then after melting, the plastic part ends are joined together. For this, the heating mirror arranged in between is removed and the plastic parts are pushed together. Immediately after melting, the resulting melt regions on the end faces of the plastic part ends are inspected by means of a camera. This takes place in a short time window during removal of the heating mirror and before the plastic part ends are brought together.

Preferably, the melt regions are inspected by the camera before the two plastic part ends are joined together. The inspection thereby takes up no additional time, but is carried out during the welding process so that the weld region does not cool further before joining.

In a preferred embodiment, the end faces of the plastic parts are photographed by the camera at an oblique viewing angle. Because of this, the camera need not be first brought frontally between the end faces of the plastic part ends, but the camera may be fixedly arranged outside the end faces or offset thereto, in order to photograph the end faces with the melted region immediately after melting.

It has proved advantageous if the image taken by the camera is straightened for analysis. By straightening the image, the image taken obliquely is converted into a frontal image. This allows the image to be analysed by means of an image analysis system and the quality of the melt region of the end faces to be classed as satisfactory or unsatisfactory for the weld. It is advantageous that, if the quality is classed as unsatisfactory, the welding process is stopped and the plastic part ends re-planed and re-melted, or the parts to be welded are removed from the welding machine and replaced by new ones. This early inspection of the melt region and early quality detection can firstly save material losses in that it is not necessary to cut out the entire weld seam but merely re-plane the two individual end faces, and secondly also save time in that unnecessary steps can be avoided if defects in the melt region or insufficient quality are detected in good time.

Evidently, the camera may already be used to identify the clamped plastic parts, whereby autonomously e.g. the dimensions, material and other properties of the plastic parts to be welded can be detected and transmitted to the butt welding machine or controller; this may avoid manual input and further contribute to fault reduction.

It is advantageous if the image taken by the camera at an oblique viewing angle is converted into a frontal image. As already stated, this conversion serves for analysis of the images. The straightened or frontal image from conversion allows detection and analysis of cavities, inclusions, blisters, burns, contaminants and other undesirable structural changes. Preferably, an image analysis system and an algorithm evaluate which melt region meets the required quality and which does not. It Is advantageous if the algorithm self-optimises using empirical values, or is optimised by operating staff using entered empirical values, or is self-learning.

It is advantageous if the image is taken from obliquely below onto the opposite end face of the plastic part end.

The butt welding machine according to the invention for end-face welding of plastic parts and for performance of the method for quality inspection of a butt weld of plastic parts comprises a base unit, a plane, a heating mirror, a controller, and at least two coaxially mutually opposite clamping devices and two mutually facing front faces, wherein at least one camera for photographing the plastic part end faces is arranged on the butt welding machine.

The butt welding machine according to the invention has a stable base unit on which preferably the plane and also the heating mirror are arranged so as to be pivotable and displaceable along the longitudinal axis. Thus at the time of the respective method step, the plane or the heating mirror can be pivoted between the plastic part ends to carry out the corresponding process step. In order to control the weld process, the butt welding machine has a controller which controls the temporal progression and temperatures of the procedure. The plastic parts to be welded together, preferably pipe components, are clamped in the coaxially arranged clamping devices of the butt welding machine. Preferably, at least one of the clamping devices of a clamped plastic part, or on one side of the butt welding machine, can be displaced along the longitudinal axis in order to position the end faces of the plastic part ends according to the method step, and then join the plastic parts together. The butt welding machine according to the invention has two opposite front faces, between which the plane and the welding mirror are pivoted.

The plastic part ends protrude beyond or project over the front faces in order to be joined together. The two front faces lie opposite one another and form the front faces, facing the welding region, of the two clamping units of the butt welding machine, wherein one of the plastic parts is arranged in each clamping unit so that the plastic parts can be welded together. The front faces are formed by the two mutually facing end faces of the clamping units of the butt welding machine. The front faces are preferably formed by two mutually facing clamping devices of the two plastic parts or by the base unit. To photograph the plastic part end faces, at least one camera is arranged on the butt welding machine. It is advantageous if the camera is arranged on a rigid, non-pivoting unit of the butt welding machine, preferably not on the plane or on the welding mirror.

It is advantageous if the camera is fixedly arranged on the welding machine. Because the camera does not move even during photographing, the image is very clear and sharp.

Preferably, the camera is arranged at the front face of the butt welding machine. Thus it can be directed onto the end face of the plastic part ends. It is advantageous if the camera is arranged in a depression in the front face so as to be protected. It is also advantageous if it is arranged obliquely to the vertical front face in order to achieve an oblique orientation onto the opposite end faces of the plastic part end.

In a preferred embodiment, the camera is arranged offset relative to the longitudinal axis and has an oblique viewing angle for photographing the end faces of the plastic part ends. The camera is thus not oriented frontally or perpendicularly onto the end faces but is offset from the centre of the cross-section of the plastic part.

Preferably, the camera is arranged laterally offset relative to the end face of the plastic part.

Preferably, at least two cameras are arranged in the butt welding machine, wherein the cameras are each arranged in one of the front faces of the butt welding machine and oriented onto the opposite end faces of the plastic parts.

It has proved advantageous if the cameras are arranged in the front face below the plastic part to be welded. Thus the cameras can photograph the welding region at an obliquely upward viewing angle onto the opposite end faces.

All possible embodiments can be combined freely with one another.

### BRIEF DESCRIPTION OF THE DRAWINGS

An exemplary embodiment of the invention is described with reference to the figures, wherein the invention is not restricted just to the exemplary embodiment. In the drawings:

FIG. 1 shows a three-dimensional view of two mutually opposite and clamped plastic part ends,

FIG. 2 shows a three-dimensional view of two mutually opposite plastic part ends with detectable melt region, and

FIG. 3 shows a front view of a part region of the butt welding machine.

### DESCRIPTION OF THE PREFERRED EMBODIMENTS OF THE INVENTION

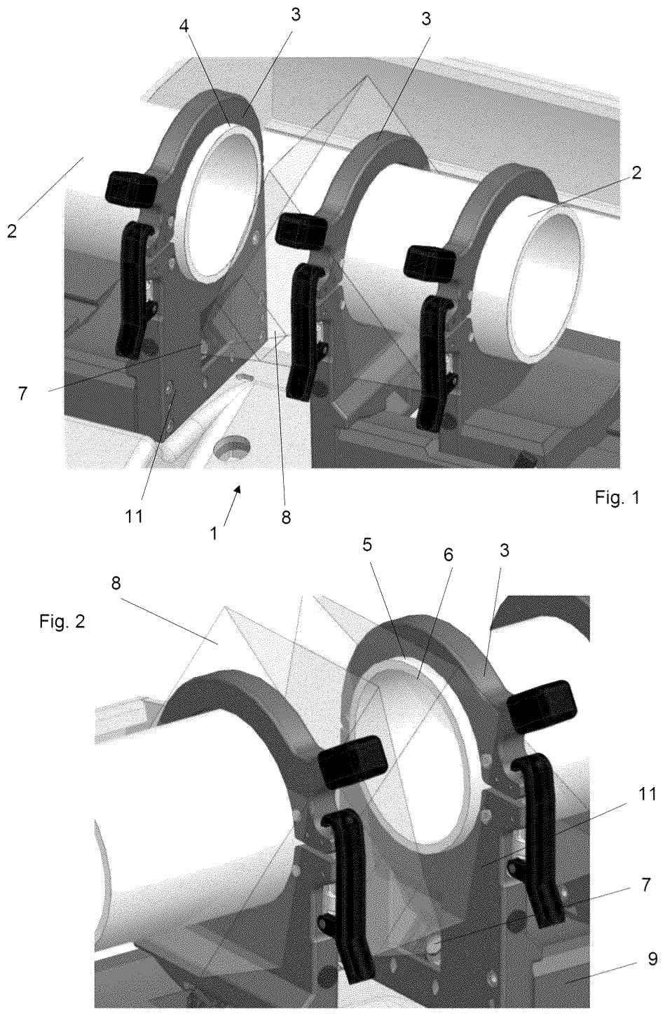

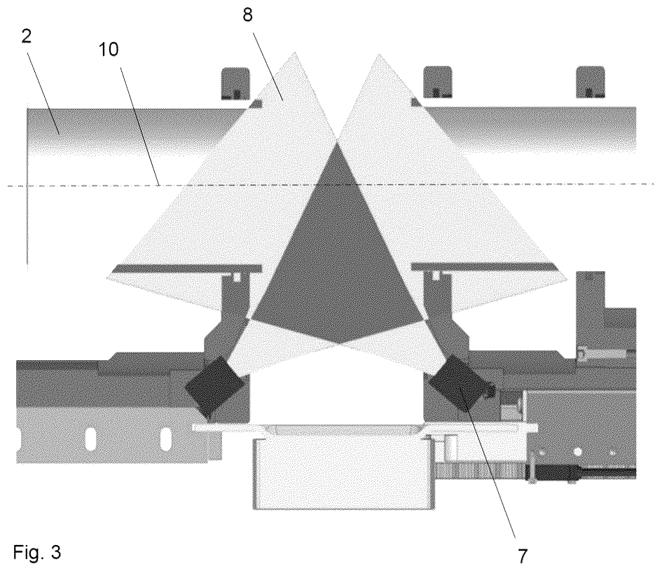

The drawing shown in FIG. 1 illustrates a part region of a butt welding machine 1 according to the invention with clamped plastic parts 2 to be welded, preferably pipeline components 2. The butt welding machine 1 has a base unit 11, a plane (not shown) and a welding mirror (not shown). The butt welding machine 1 according to the invention also comprises clamping devices 3 which are arranged coaxially to one another and in which the plastic parts 2 are fixed. The butt welding machine 1 has two mutually facing front faces 11, over which the ends 6 of the plastic parts 2 to be welded protrude. The front faces 11 are preferably formed by mutually facing end faces of two clamping devices 3 or the base unit 9. The front faces 11 form the vertical fronts of the two clamping regions of the butt welding machine 1, which each clamp one of the plastic parts 2 to be joined together. A camera 7 for photographing the end face 4 of the plastic part 2 is arranged in each front face 11. The figures clearly show the oblique viewing angle 8 of the cameras 7. The cameras 7 are preferably arranged obliquely to the front face 11 in the welding machine 1. Because the cameras 7 are fixedly arranged on the front faces 11, as soon as the melt phase has ended by removal of the heating mirror, a photograph of the melted region 6 is taken from the oblique viewing angle 9. Evidently also, for assessment of the surface quality, the end faces 4 of the plastic parts 2 may be photographed directly after planing or before planing in order to identify the material or components. This allows autonomous adjustment of the butt welding machine 1 on the basis of the plastic parts to be welded. With the controller and the data stored therein, the machine can identify the parts to be welded, perform all necessary adjustments and carry out the welding process automatically. Also a welding report can be produced directly with the recorded images and the images can be assessed using the image analysis system, on the basis of which the recorded and straightened images can be compared with predefined values or images and classed as satisfactory or unsatisfactory.

What is claimed is:

1. A method for quality assessment of a butt weld of plastic parts, welded by a butt welding machine, comprising wherein two plastic parts are clamped in a coaxial position to one another by means of clamping devices and fixed, wherein the mutually opposite end faces of the plastic parts are planed flat by means of a plane which can be introduced in between, and the plastic part ends are melted by means of a heating mirror which can be introduced in between and then joined after melting, wherein after melting, the resulting melt regions on the end faces of the plastic part ends are inspected by means of at least one camera.

2. A method according to claim 1, wherein the melt regions are inspected by camera before the two plastic part ends are joined together.

3. A method according to claim 1, wherein the end faces of the plastic parts are photographed by the camera at an oblique viewing angle.

4. A method according to claim 3, wherein the image taken by the camera is straightened for analysis.

5. A method according to claim 3, wherein the image taken by the camera from an oblique viewing angle is converted into a frontal image.

6. A method according to claim 1, wherein the straightened image, or the image converted into a frontal image, of the melt region at the end face is classed as of satisfactory or unsatisfactory quality by means of an image analysis system.

7. A butt welding machine for performance of the method according to claim 1, comprising a base unit, a plane, a heating mirror, a controller, at least two coaxially mutually opposite clamping devices and two mutually facing front faces, wherein at least one camera for photographing the plastic part end faces is arranged on the butt welding machine.

8. A butt welding machine according to claim 7, wherein the camera is fixedly arranged on the butt welding machine.

9. A butt welding machine according to claim 7, wherein the camera is arranged at the front face of the butt welding machine.

10. A butt welding machine according to claim 7, wherein the camera is arranged offset relative to the longitudinal axis and has an oblique viewing angle for photographing the end faces of the plastic part ends.

11. A butt welding machine according to claim 7, wherein at least two cameras are arranged in the butt welding machine, wherein the cameras are each arranged in one of the front faces of the butt welding machine and oriented onto the opposite end faces of the plastic parts.
